(19) United States
(12) Patent Application Publication
(10) Pub. No.: US 2025/0310591 A1
(43) Pub. Date: Oct. 2, 2025

(54) METHOD AND SYSTEM FOR SELECTION OF CUSTOMIZED VISUAL INDICATIONS

(71) Applicant: ThinkAnalytics Ltd., Glasgow, Lanarkshire (GB)

(72) Inventors: Christopher McGuire, Glasgow (GB); Peter Docherty, Glasgow (GB)

(73) Assignee: ThinkAnalytics Ltd., Glasgow, Lanarkshire (GB)

(21) Appl. No.: 18/622,450

(22) Filed: Mar. 29, 2024

(51) Int. Cl. H04N 21/431; H04N 21/25; H04N 21/258; H04N 21/442

(52) U.S. Cl. CPC H04N 21/4312; H04N 21/251; H04N 21/25891; H04N 21/44222

(57) ABSTRACT

A computer-implemented method comprising: obtaining user data for a user, wherein the user data comprises or represents user activity and/or content metadata associated with user activity; obtaining metadata and/or one or more other properties associated with a plurality of visual indications associated with a content item; selecting one or more of the plurality of visual indications based on at least the user data and the visual indication metadata and/or the one or more other properties of the visual indication; displaying the selected one or more visual indications, for example, as part of a content selection interface.

### TECHNICAL FIELD

The present disclosure relates to a system and method for use in content recommendation systems. In examples, the system and method includes selecting or otherwise obtaining customized visual indications or representations, for example, in the form of images or other visual formats for content items.

### BACKGROUND

Developments in technology mean that users are able to access content via a wide array of different mechanisms, and via a wide array of different sources. For example, television channels, radio stations, video-on-demand and other streaming services, social media and other internet content sources provide a vast array of content available to a user.

By providing a large volume of content, content distribution platforms can cater to a large range of different user preferences and provide content previously unseen to a user to hold the user's interest. As part of the content distribution, it is known to display one or more visual indicators, for example, images, representing one or more content items via a content selection interface. Providing such content selection interfaces for a large number of users may present technical challenges.

### SUMMARY

According to a first aspect, there is provided, a computer-implemented method comprising: obtaining user data for a user, wherein the user data comprises or represents user activity and/or content metadata associated with user activity; obtaining metadata and/or one or more other properties associated with a plurality of visual indications associated with a content item; selecting one or more of the plurality of visual indications based on at least the user data and the visual indication metadata and/or the one or more other properties of the visual indication; displaying the selected one or more visual indications, for example, as part of a content selection interface.

The metadata and/or the one or more properties associated with the visual indications represent or are indicative of at least one of: an identity of a visual event, subject or object in and/or a setting or scene of the visual indication; a mood, theme or sentiment of the visual indication.

The method may comprise determining a score representing relevance for each of the visual indications based on user data and the metadata and/or the one or more other properties of the visual indication and selecting the most relevant visual indication based on the score.

The metadata and/or other properties for the one or more visual indications may comprise an identifier or descriptor for a visual event and/or one or more people, objects or scenes of the visual indication.

The visual indications may comprise at least one of an image, sequence of images, video or other visual format.

The visual indications may comprise a sequence of images or video. The visual indication may comprise a digital image format, a graphics interchange format (GIF), a sequence of images, a video or other visual format. The visual indication may comprise any media configured to be tagged with associative metadata.

The user data may be stored as a user profile. The method may comprise selecting the visual indication based on said user profile. The method may further comprise generating the user profile. The method may comprise a method of configuring, optionally displaying, a content selection interface. The method may comprise displaying the selected visual indication as part of the content selection interface. The user data may be stored as a user profile comprising a set of properties and/or scores selected from a pre-determined set and the visual indication metadata may comprise a set of properties and/or weights selected from the same pre-determined set. The metadata may comprise scores and/or weights for a plurality of metadata categories taken from a set.

The method may further comprise performing one or more visual indication processing procedures, for example, image processing procedures, to obtain the metadata and/or one or more other properties for the plurality of visual indications.

The method may comprise storing said obtained visual indication metadata and/or other properties. Obtaining said image metadata and/or other properties may comprise retrieving metadata for said one or more visual indications that has been previously obtained by processing said one or more visual indications.

The plurality of visual indications may comprise a plurality of images. The plurality of visual indication processing procedures may comprise a plurality of image processing procedures. The plurality of image processing procedures may comprise at least one of: an object and/or facial recognition procedure and/or a mood and/or theme and/or sentiment detection procedure.

The visual indication processing procedure may comprise processing said plurality of visual indications to identify one or more metadata properties from a pre-determined set of properties and, optionally, storing said one or more identified properties as metadata for the visual indication.

The visual indication processing procedures may comprise at least one: an object and/or facial recognition procedure and/or a mood and/or theme and/or sentiment detection procedure.

The visual indication processing procedure may comprise processing said plurality of visual indications to identify one or more metadata properties or items from a pre-determined set of properties or items and, optionally, storing said one or more identified properties as metadata for the visual indication.

The plurality of visual indications may be obtained from a third party, for example, a content provider or other data provider and processed to assign first party metadata, for example, metadata from a content distribution system and/or middleware operator.

The plurality of visual indications may be obtained together with metadata from a third party and wherein the method comprises processing the set of visual indications to enrich and/or expand third party metadata and wherein the selection of the visual indication is based on the enriched and/or expanded metadata.

The user data may comprise data representing user preferences based on user engagement with a plurality of content items, for example, one or more content libraries. The user data and/or associated metadata may comprise or form a user profile for a user determined based on previous user engagement with a plurality of content libraries. The user data and/or associated metadata may comprise data produced by a metadata enriching process.

The user data may comprise metadata and associated weight in a set of pre-determined metadata categories and wherein obtaining the image metadata comprises at least mapping pre-determined metadata to generate further image metadata in said set of metadata categories.

The method may comprise obtaining a plurality of images from a third party and selecting a visual indication based on user data.

The method may comprise performing a matching process between the user data and the visual indication metadata to identify matched or common metadata and selecting the visual indication based on said matched or common metadata. The matching process may comprise comparing the content metadata associated with the user activity and the metadata of the visual indication. The matched metadata may comprise one or more common metadata items, for example, properties, characteristics or other attributes.

The method may comprise performing a matching process between the user data and the visual indication metadata to identify one or more matched or best matched metadata properties and selecting the visual indication based on said matched properties.

The user data may be represented as a feature vector in a vector space and the method comprises representing the one or more visual indications as vectors in the same vector space, wherein the selection process is based on determining a distance between or a measure of overlap or projection between the user vector and the vectors representing the one or more visual indications.

A vector representing a visual indication may comprise a visual indication vector. The method may comprise selecting the visual indication based on the closest visual indication vector to the user vector.

The method may comprise determining a measure of overlap and/or projection between the feature vector for the user and the visual indication vectors and wherein the selection is based on the measure of distance and/or overlap and/or projection.

The method may comprise performing a dot or inner product between the user vector and the visual indication vectors to obtain a plurality of scores and selecting the visual indication based on the scores, for example, the highest score.

The user data and the metadata for the visual indications may comprise one or more metadata items selected from the same pre-determined set of metadata categories, and wherein the method comprises counting the number of matching metadata items for each visual indication and selecting the visual indication based on the count.

The method may comprises identifying at least one property of the image metadata that is similar and/or matched to at least one property of the user data and obtaining the image based on said identified property

The selection of the visual indication is dependent on a priority score for a content item or the visual indication and/or on current or predicted system performance and/or on a user engagement score for the content item and/or for the visual indication.

The one or more properties of the visual indication may comprise a user engagement or popularity score or user conversion score.

The selection of the visual indication may be performed in dependence on one or more of:
a) a system performance metric
b) a prediction of system performance or system load
c) a performance metric of a content selection interface

The method may comprise assigning a priority score to a content item. The priority score may be assigned in accordance a determined value of the content item. The selection of the visual indication may be based on the priority score. A default image may be selected based on the content item and/or visual indication having a low priority score.

The metadata and/or other property of the visual indication may comprise a user engagement or conversion score representing previous user engagement with the content item for the visual indication and wherein the selection of the user engagement is based on said user engagement or conversion score.

The method may comprise tracking user engagement for a content item dependent on the visual indication presented to the user and storing a score for each visual indication representing said user engagement, wherein the selection of the image is based on said user engagement score.

The method may comprise determining whether to display a default image or to select one or more visual indication based on at least one of: a user engagement metric, a priority score and/or system performance metric.

The user engagement score may represent a popularity and/or recency. The user engagement score may comprise a score representing user engagement in a preceding time period.

The properties of the visual indication may comprise at least one of: a priority score, a popularity score, a user engagement score and/or a conversion score. The properties of the visual indication may comprise a score representing success of the visual indication for one or more users, optionally a plurality of users. The properties of the visual indication may comprise a conversion rate.

The metadata may comprise or represent one or more parameters, properties and/or characteristics of the associated content, for example, at least one of: program title, time, duration, content type, program categorisation, actor names, genre, release data, episode number, series number, style, mood, language and theme.

The user data and/or visual indication metadata may comprise one or more metadata properties or items selected from a predetermined set of properties. The at least one property may comprise a set of tags and/or other metadata representing properties of an item of content and/or a visual indication. The user data and/or visual indication metadata may comprise scores or weights for a plurality of metadata categories or items selected from a pre-determined set.

The user data may be representative of one or more preferences of the user and selecting the visual indication is based on said one or more preferences, optionally, wherein the one or more preferences are determined based on historical content engagement data collected for the user.

The method may comprise obtaining a group of content item recommendation candidates and wherein the method further comprises selecting a visual indication for one or more of the content item recommendation candidates based on metadata and/or one or more properties of the visual indication.

The visual indication selection may be performed for a subset of content item recommendation candidates based on a priority score and/or current or predicted system performance and/or an engagement metric.

The content selection interface comprises a plurality of scrollable carousels and the method comprises presenting the selected one or more visual indications in a respective carousel of the user interface.

The method further comprises presenting an interactive user interface operable by a user to select one or more content items in response to receiving user input. The one or more images are displayed as part of a user interface, for example, an electronic program guide, operable by a user to select one or more content items, wherein the user interface. The one or more images are displayed as a moveable graphical element such that images representing a subset of the recommendations are displayed at one time. The content selection interface comprises a plurality of scrollable carousels and the method comprises providing respective groups of content to the user in respective carousels of the user interface, and the ordering of the groups of content comprises ordering the carousels in the user interface. The related group of content is a group of content having the same or a related theme or comprising at least one content item in common.

The content selection interface may comprise a user interface of an electronic program guide, EPG, and the method is performed in conjunction with a method of providing television content or other content to each of a plurality of users using a content distribution system, wherein a user device of each user displays the EPG that is operable by the user of the user device to select one or more items of television or other content; and in response to the selections a content distribution system distributes the selected items of television content or other content to the user devices for viewing by the users during content viewing sessions.

The content in the content selection interface may be selectable by the user in the content selection interface to present the selected content.

The method may comprise displaying the selected visual indication together as part of a content selection interface. The method may comprise receiving a signal representing a selection of one or more content items by a user in response to displaying one or more selected visual indications for said content items.

According to a second aspect, there is provided a system comprising processing circuitry configured to: obtain user data for a user, wherein the user data comprises or represents user activity and/or content metadata associated with user activity; obtain metadata and/or one or more other properties associated with a plurality of visual indications associated with a content item; select one or more of the plurality of visual indications based on at least the user data and the visual indication metadata and/or the one or more other properties of the visual indication; display the selected one or more visual indications, for example, as part of a content selection interface.

The system may comprise a display. The system may comprise a user device comprising a display. The one or more visual indications may be displayed on said display.

The system may comprise a visual indication store, or other data storage resource. The visual indication may be retrieved from the visual indication store. The metadata may be stored on the visual indication store or at a separate data storage resource. The metadata may be obtained from the visual indication store or other data storage resource.

According to a third aspect, there is provided a non-transitory computer-readable medium that comprises computer-readable instructions that are executable to: obtain user data for a user, wherein the user data comprises or represents user activity and/or content metadata associated with user activity; obtain metadata and/or one or more other properties associated with a plurality of visual indications associated with a content item; select one or more of the plurality of visual indications based on at least the user data and the visual indication metadata and/or the one or more other properties of the visual indication; display the selected one or more visual indications, for example, as part of a content selection interface.

Features of one aspect may be provided as features of another aspect, in any appropriate combination. For example, method features may be provided as system features and vice versa.

### BRIEF DESCRIPTION OF THE DRAWINGS

Various aspects of the invention will now be described by way of example only, and with reference to the accompanying drawings, of which:

FIG. 1 is a schematic diagram of a digital content recommendation system;

FIG. 2 is representation of certain database learning tables used by the system of FIG. 1;

FIG. 3 is an overview of a method of a workflow for generating customized visual indications, for example, images, for one or more users;

FIG. 4 is an overview of a method of generating customized visual indications, for example, images, for one or more users;

FIG. 5 is a schematic view of a content selection interface;

FIG. 6 is a schematic view of part of the content selection interface of FIG. 5;

FIG. 7 is a schematic of a system arrangement, and

FIG. 8 is a schematic of an alternative system arrangement to that of FIG. 7.

### DETAILED DESCRIPTION

The embodiments described below relate to methods and systems for selecting or otherwise obtaining visual indications, such as images. This selection may be part of a content item recommendation process. In some embodiments, the methods and systems include obtaining customized images for a user based on user data, such as user engagement data.

In the context of content recommendation systems, it is to be understood that there may be a very large number of users posing significant technical challenges for analyzing and interpreting user activity. Therefore, providing customized images or other visual indications for users and/or groups of users in real-time may present technical challenges. By providing customized visual indications for users of a content recommendation system, user engagement with certain content may be encouraged and increased.

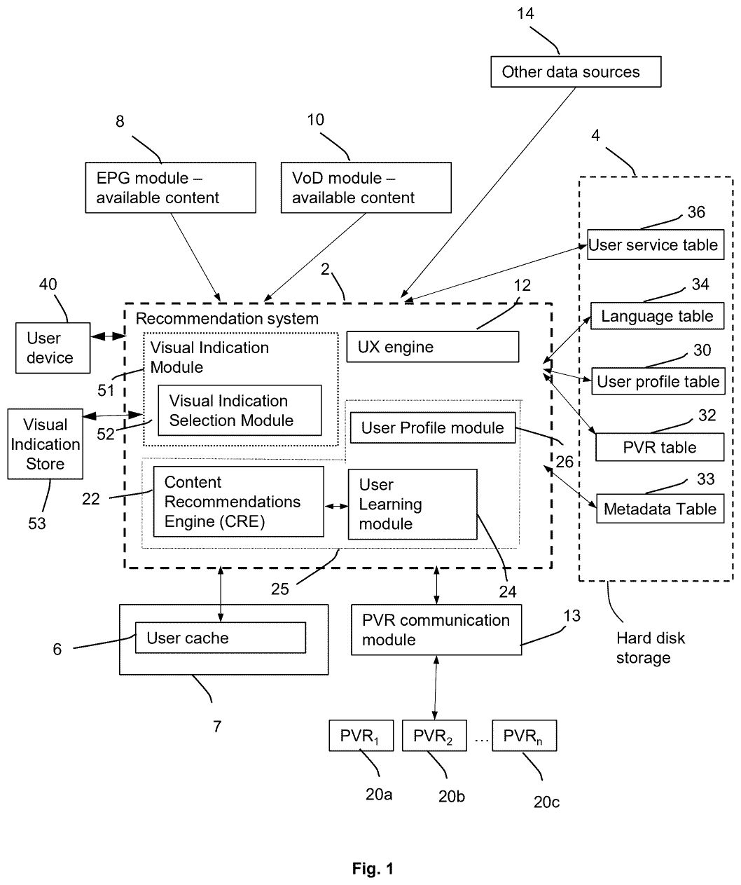

FIG. 1 shows a schematic diagram of content recommendation system according to an embodiment, which is operable to generate content recommendations for users based on first party data in the form of, for example, user actions performed in relation to their selection, viewing and other actions in relation to TV content provided by a TV distribution system, and/or in relation to other content. The content recommendation system is configured to perform one or more content recommendation methods. As part of the content recommendation system, the system has additional features and modules for providing an additional level of customization. In particular, a further data module is provided as described in the following.

The system in the embodiment of FIG. 1 comprises a content recommendation system 2 that comprises a content recommendation engine (CRE) or module 22 and linked to a first storage resource in the form of a hard disk storage device 4, which is used to store various user data. The recommendation system 2 is also communicatively linked to a second storage resource in the form of a local storage device that includes at least one cache, for example a user cache 6. In the embodiment of FIG. 1 the local storage device is in the form of RAM 7 but any suitable storage device may be used in alternative embodiments. The user cache 6 may be used for temporary storage of user data obtained from the hard disk storage device 4 during a user session.

The content recommendation engine (CRE) 22 can apply a set of processes, to determine, in real time, content recommendations for a user 205 based on user data and available content.

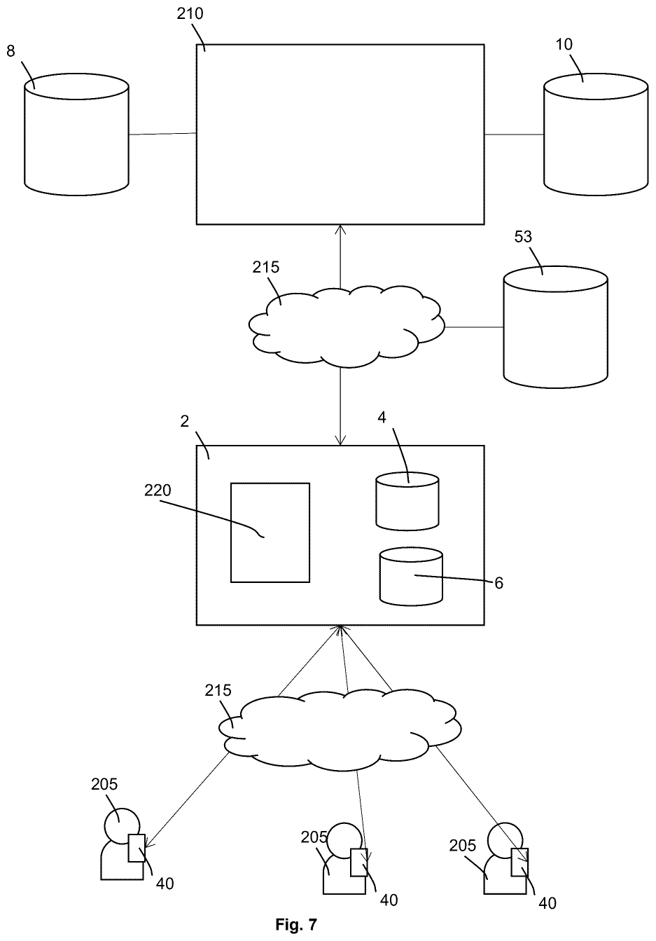

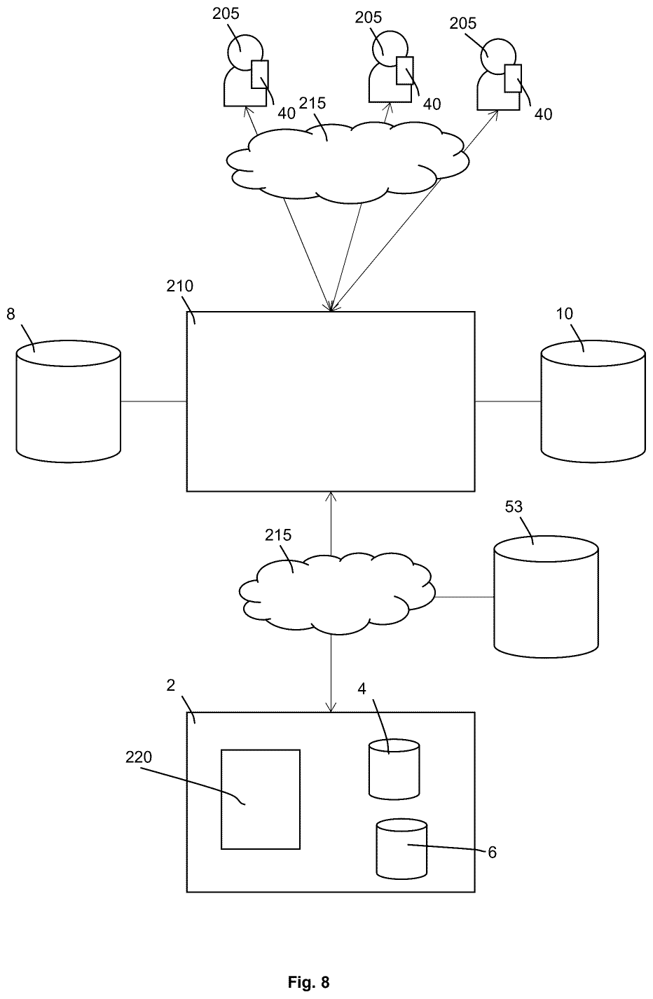

FIG. 1 shows a schematic diagram of a system 1 that comprises a user experience (UX) engine 12 for configuring user content selection interfaces that allow users 205 (see FIGS. 7 and 8) to navigate and select content from a content service provider (210, also shown in FIGS. 7 and 8). In particular, the user experience (UX) engine 12 can be used to provide customized user content selection interfaces that are customized or otherwise specifically configured to a specific user 205 or group of users 205. The customization can comprise, for example, customizing the order in which groups of content is presented to a user 205 or groups of users 205 so that groups of content more likely to be of interest to the user 205 are presented earlier, or in preference to groups of content that are less likely to be of interest to that user 205.

In the example of FIG. 1, the user experience (UX) engine 12 is provided as part of a more general recommendation system 2 that comprises a content recommendation engine (CRE) 22 that can apply a set of processes to determine, in real time, content recommendations for a user 205 based on user data and available content. This arrangement can be beneficial as there may be some cross-over in the data utilised such that the UX engine 12 can in some examples share or otherwise leverage data used by the CRE 22, which can minimise data storage and other services required to operate both systems. However, the disclosure is not limited to this arrangement and in other examples the UX engine 12 can be provided as a dedicated stand-alone system or as part of a content provider's user interface system or in another suitable component of a content provision system or associated support system.

The UX engine 12 is configured to take into account previous interactions that the user 205 has had with user content selection interfaces. These could include interactions the user 205 has had with the user content selection interface that the system 1 is currently looking to configure and/or with other user content selection interfaces. Beneficially, such user interactions may comprise first party data in the form of, for example, user actions performed in relation to their selection, viewing and other actions in relation to content such as but not limited to TV content provided by a TV distribution system or other types of content.

FIG. 1 depicts a visual indication module 51. In some embodiments, the visual indication module 51 or the visual indication store has a visual indication analyzer 52. The visual indication module 51 may be configured to obtain visual indications for a content item based on user data representing user activity and/or content metadata associated with said user activity. The visual indication module 51 also uses metadata associated with the visual indication and/or one or more other properties of the visual indications to select the visual indication. In the following embodiments, the visual indications are images, however, these may be any visual format, for example, a video or other visual based format. Visual indications for content items may alternatively be referred to as content indications.

The visual indication module has a visual indication selection module 52 configured to select one or more of a plurality of candidate visual indications, in this embodiment, images based on user data and based on properties of the image, for example, associated image metadata or other properties. The visual indication selection module may also be referred to a visual indication selector.

The visual indication module 51 is configured to communication with one or more data sources. In the following embodiments, the visual indication module 51 is configured to obtain a visual indication for one or more users based on user data collected for a user. As described elsewhere, the EPG module 8 and the VOD module 10 obtain information concerning available content from the content sources, for example, a TV service operator or other content service operator. As part of the visual indication generation, user data, for example, in the form of a user profile is obtained. In embodiments, the user profile is obtained by the visual indication module 51 from user profile module 26 or user profile table 30.

In the present embodiment, the visual indication module 51 is depicted as a separate module to the recommendation system 25, however, it will be understood that the further metadata module may be provide as part of the recommendation service or as part of the UX engine. In particular, in some embodiment, a visual indication may be selected during a recommendation procedure executed by the CRE. In some embodiments, the visual indication may be selected during a content selection process controlled by the UX engine.

In some embodiments, a visual indication analyzer is provided to analyze visual indications. In some embodiments, the visual indication module includes a visual indication analyzer in the form of an image analyzer configured to execute image analysis methods and procedures to obtain image metadata from the images.

The content recommendation engine (CRE) 22 in this example is provided as part of an affinity profile generation system, which is operable to generate affinity profiles for users 205 based on first party data in the form of, for example, user actions performed in relation to their selection, viewing and other actions in relation to TV content provided by a TV distribution system, and/or in relation to other content. The recommendation system 2 in the embodiment of FIG. 1 is also able to provide content recommendations to users as well as generating affinity profiles. Content recommendations may be provided in real time or near real time for many thousands, tens of thousands or even hundreds of thousands or more users, for example using techniques as described in UK Patent No. GB 2574581 or U.S. Pat. No. 11,343,573, the content of each of which is incorporated in full herein by reference. However, as noted above, this is an optional arrangement, and the UX engine 12 need not be provided as part of such a recommendation system 2 and can be provided as a stand-alone system or as part of a system with other functionality.

Some example modes of operation are described below in relation to PVRs associated with users, but content may be provided or accessible via any suitable devices, for example set-top boxes, smartphones, PCs or tablets or any other suitable content delivery mechanism.

As discussed further below, the recommendation system is able to communicate, either directly or indirectly, and either via wired or wireless connection, with very large numbers of users or user devices and to provide recommendations for or derived from such users or user devices. Other than some PVRs which are shown schematically in FIG. 1, only a single user device 40 is shown in FIG. 1 for clarity.

The recommendation system 2 is also linked to sources of information concerning available content, in this case an EPG module 8 and a Video-on-Demand (VOD) module which provide information concerning content available to a user via an EPG (for example, scheduled TV programs on a set of channels) and via a VOD service. In alternative embodiments, a variety of other sources of content may be available as well as, or in addition to, EPG and VoD content, for example internet content and/or any suitable streamed content via wired or wireless connection. As discussed further below, recommendation system 2 is able to communicate, either directly or indirectly, and either via wired or wireless connection, with very large numbers of users 205 or user devices 40 and to provide recommendations for or derived from such users 205 or their user devices 40. Other than some PVRs which are shown schematically in FIG. 1, only a few user devices 40 are shown in FIG. 1 for clarity, but it will be appreciated that more or less user devices 40 could be present. The user devices 40 could include, as examples only, a user's mobile phone, smart TV, tablet computer, laptop, smart watch or other suitable viewing device. Although the user devices 40 could belonging to the user 205, they could also comprise any other device that the user 205 is logged into.

The EPG is provided as an example of a content selection interface that allows users 205 to look for content available from the service provider and to select content, e.g. for download, streaming and/or viewing. However, the present disclosure is not limited to EPGs and could also be applied to other content selection interfaces, e.g. for music provision services, audio book services, film streaming services, creator content, book or article selection interfaces, amongst others. The content may comprise video, audio, text, images, or other data.

In the embodiment of FIG. 1, the UX engine 12, the EPG module 8, the VOD module 10, the recommendation system 2, the User Cache 6, the PVR Communication module 12, the EPG module 8 and the User Learning module 24 are implemented in a server. The server includes communication circuitry that enables communication between the server, or appropriate components of the server, with each of the user devices, and with the content sources, for example, a TV service operator or other content service operator.

It will be understood that requests and results may be communicated between different parts of a network using one or more application programming interfaces (APIs). The API defines the parameters and other data to be included in a request and the form and format of the results from the request. In particular, the content recommendation procedures described in the following are available through one or more APIs.

Any other suitable implementation of the EPG module 8, the VOD module 10, the recommendation system 2, the CRE 22, the user cache 6, the PVR communication module 12, the EPG module 8 and the user learning module 24 may be provided in alternative embodiments, for example they may be implemented in any software, hardware or any suitable combination of software and hardware. Furthermore, in alternative embodiments, any one of the components as described in relation to the embodiment of FIG. 1 or other embodiments may be combined with any other one(s) of the components, or any one of the components may be split into multiple components providing the same or similar functionality.

The EPG module 8 and the VOD module 10 obtain information concerning available content from the content sources, for example, a TV service operator or other content service operator. The content information comprises metadata of content, for example, television program metadata. The metadata may be representative of a variety of different content parameters, properties or attributes, for example but not limited to program title, time, duration, content type, program categorisation, actor names, genre, release date, episode number, series number. It is a feature of the embodiment that the metadata stored at the EPG module 8 and the VoD module 10 may also be enriched with additional metadata, for example by the operator of the system, such that additional metadata to that provided by the content sources or other external sources may be stored. The content information also include synopses and other descriptive data for content items.

In the embodiment of FIG. 1 the system operates together with three sources of content for a user device: real-time linear television, for example terrestrial or satellite broadcast television; one or more video-on-demand (VOD) services, and pre-recorded video content stored on one or more personal video recorders (PVR). In alternative embodiments, further sources of content as well as or instead of those shown may be used.

The operation of the digital content recommendation system is controlled by the recommendation system 2. As can be seen in FIG. 1, the recommendation system 2 is configured to communicate with the one or more content information modules: the electronic program guide (EPG) module and VoD module 10. The recommendation system 2 is also configured to communicate with the user cache 6 local to the recommendation system 2, the hard disk storage resource 4 and the one or more PVRs. A data access layer provides a communication interface between the recommendation system 2 and the hard disk storage resource 4. A personal video recorder (PVR) communication module 12 provides a communication interface between the one or more PVRs 20a, 20b, . . . 20z and the recommendation system 2.

As discussed in more detail below, the user profile module 26 is operable to use first party data obtained by an operator of the system to determine user activity profiles of individual users 205 or sets of users 205, that are representative of actions of a user 205 with respect to content selection interfaces. The content recommendation engine (CRE) 22 can apply a set of processes to determine, in real time, content recommendations for a user 205 based on user data and available content.

The recommendation system 2 has a content recommendation engine (CRE) 22, item based procedure executing module 26 and a user learning module 24. The CRE 22 can apply a set of processes or procedures to determine, in real time, content recommendations for a user based on user data and available content.

The user learning module 24 receives data indicative of selections or other actions by a user and builds up a set of user data, for example comprising or representing a user history or profile, which is stored in the hard disk storage 4, and which is used in generating personalised recommendations for the user.

The UX engine 12 allows for the content selection interface to be configured, which may be at least in part responsive to input from an operative, such as an operative of a content provider service, and/or at least in part automatically, or any combination thereof.

The UX engine 12 allows groups of content to be created. The user content selection interface presents the content items for selection by the user 205 in the groups of content. In an example, each group of content may correspond to a different carousel in a carousel type user interface, but the present disclosure is not limited to this. In some examples, at least one or each group of content may represent a different theme, such as war movies, romances, action movies, nature programs, news and current affairs, and the like. However, this need not be the case, and at least one or each group could be simply selected by the operative or another party. The UX engine 12 also allows the way in which the groups of content are provided or displayed to the user 205 to be customized to that individual user 205 or group of users 205. For example, the UX engine 12 allows customization, e.g. automated customization, of the order in which groups of content are provided to the user in the user content selection interface, which may be an order in which the carousels corresponding to different groups are provided in the content selection interface. In some examples, this comprises allowing selected groups of content to be fixed in a set place in an ordering of the groups of content. In examples, this comprises allowing the UX engine 12 to determine a customized ordering of at least some or all of the groups of content for each user 205 or group of users 205, which may be based at least in part on groups of content that the user 205 or group of users 205 have previously interacted with in some way, e.g. whilst using a user content selection interface.

The ordering of the groups of content (and content recommendations in examples in which the UX engine 12 is part of a recommendation system 2) can be based on user actions, wherein at least some of those user actions include user interaction with content recommendation user interfaces. FIG. 1 shows user actions and requests for recommendations or ordering of content being communicated directly to the recommendation system 2 from the user devices 40. In addition to receiving requests for recommendations of content or ordering of groups of content, the recommendation system 2 is configured to log user activity. By logging user activity and storing activity over an extended period of time, the recommendation system 2 and the hard disk storage 4 can build up an overall picture of the actions of a plurality of users relating to their interactions with content selection interfaces. User actions are turned into learn actions by the user learning module 24 to be processed by the user profile module 26, the UX engine 12 and the content recommendation engine 22.

FIG. 1 shows a user action being received by the recommendation system 2. In addition to receiving requests for recommendation, the recommendation system 2 is configured to log user activity. By logging user activity and storing activity over an extended period of time, the recommendation system 2 and the hard disk storage 4 can build up an overall picture of the viewing activities, habits and preferences of a plurality of users. User actions are turned into learn actions by the user learning module 24 to be processed the content recommendation engine 22.

FIG. 1 also has a further metadata source. In the present embodiment, this is provided on a remote computer, accessible, for example, via the cloud 215. It will be understood that the further metadata source is provided remotely from the content recommendation system and, for example, data sources 8 and 10.

The system of FIG. 1 is configured to operate with a plurality of user devices each associated with at least one user. The plurality of user devices may comprise a large number of devices, for example thousands, tens or hundreds of thousands, or even millions of devices. Each user device may be any device or combination of devices that is configured to enable a user to view or otherwise consume content. For example, each user device may be an internet-enabled device and/or a device for providing video or other content on demand and/or a device capable of receiving a real-time linear television broadcast signal. The user device may be a mobile device, for example a tablet, a smart phone or a laptop. Alternatively, the user device may not be mobile, for example, an internet browser enabled computing device, a smart television or a set-top box. The user device may also have an in-built or associated PVR for recording and storing content in some embodiments.

The user 205 may be a viewer of the user device. Alternatively or additionally, the user 205 may be a subscriber and/or customer of a service accessible through the user device.

The user cache 6 is coupled to the item based recommendation procedure module 26 and the content recommendations engine 22, and the UX engine 12 and data stored by the user cache 6 may be used by the item based recommendation procedure module 26 and the content recommendations engine 22. The recommendation system 2 can access data stored on the user cache 6. The user cache 6 may be provided in random access memory (RAM) 7.

The hard disk storage 4 is communicatively coupled to the recommendation system 2. The hard disk storage 4 stores data for use by the recommendation system 2. The hard disk storage 4 is configured to store one or more databases. Entries from the databases on the hard disk storage resource 4 can be retrieved by requests made through a data access layer. Entries in the databases may also be updated via the data access layer. The database(s) at the hard disk storage 4 store user data that is used by the CRE 22 to generate content recommendations. In the embodiment of FIG. 1 a set of database tables is provided that store information concerning the users.

In the embodiment of FIG. 1, the tables may include at least one user service table 36 that represent user service requirements, and at least one user profile table 30 that includes user attribute data that may be considered to represent a user profile. A user profile may include, for example, the following attributes: unique identifiers, for example a user identifier, a subscriber identifier, an anonymous session identifier; one or more unique geographic identifiers; a flag indicating whether or not the user has a PVR; a flag indicating whether or not the user is in debt; a flag indicating whether or not the user has opted out of receiving marketing material; one or more codes indicating one or more preferred languages of the user; a flag indicating if the user has opted out of receiving personal recommendations; the age of the user; the name of the user and the gender of the user.

In the embodiment of FIG. 1, the tables may include various user learning tables that include data representing for example the viewing activities, habits and preferences of each user. The user data can include data representing for examples explicit ratings given by a user to a particular program or other item of content. It is a feature of the embodiment of FIG. 1 that the user data also includes data representing actions, for instance viewing actions, taken by a user.

For example, if a user selects a program or other item of content and views or otherwise consumes it for greater than a threshold period of time then a learn action is generated and at least one user data item for that user is stored in at least one of the tables. The data item may include various data including for example start and stop viewing time, time slot identifier, program identifier, at least some metadata concerning the program (although such metadata may be stored separately as content data rather than user data in some embodiments, and linked to or otherwise accessed if required, for example by the program name or other identifier). The user learning module 24 determines whether user data should be stored in the tables in respect of a particular user action or set of actions. For example, if a user only views a program for a very short period of time, for instance if they are channel surfing, then user data is not stored in the user learning tables in respect of that action. User data can be stored in respect of a variety of different user actions or events, for example selecting, viewing, recording or searching for content.

In the embodiment of FIG. 1, the tables may include various user learning tables that include data representing user 205 actions, also referred to as user activity, relating to content selection interfaces on a user interface; downloading content that is in a group of content or related group of content; having watched at least part of content that is in a group of content or related group of content; bookmarking content that is in a group of content or related group of content; browsing content that is in a group of content or related group of content; recording content that is in a group of content or related group of content; adding content that is in a group of content or related group of content to virtual shopping basket or otherwise selecting for purchase or potential purchase; watching or listening to a trailer for content that is in a group of content or related group of content; playing content that is in a group of content or related group of content on a user device; purchasing content that is in a group of content or related group of content; clicking on or otherwise selecting content that is in a group of content or related group of content from a list of search results; remotely recording content that is in a group of content or related group of content; setting a reminder for content that is in a group of content or related group of content; liking, making a favorite or otherwise adding to a list content that is in a group of content or related group of content; disliking content that is in a group of content or related group of content; messaging about content that is in a group of content or related group of content; posting on social media about content that is in a group of content or related group of content; playing purchased content that is in a group of content or related group of content; stopping watching or playing content that is in a group of content or related group of content; and/or rating content that is in a group of content or related group of content, from amongst others.

For example, if a user 205 selects a program or other item of content from a content selection interface and views or otherwise consumes it for greater than a threshold period of time then a learn action is generated and at least one user data item for that user is stored in at least one of the tables. The data item may include various data including for example start and stop viewing time, time slot identifier, program identifier, which group of content the content belongs, at least some metadata concerning the program (although such metadata may be stored separately as content data rather than user data in some embodiments, and linked to or otherwise accessed if required, for example by the program name or other identifier). The user learning module 24 determines whether user data should be stored in the tables in respect of a particular user action or set of actions. For example, if a user only views a program for a very short period of time, for instance if they are channel surfing, then user data is optionally not stored in the user learning tables in respect of that action. User data can be stored in respect of a variety of different user actions or events, for example selecting, viewing, recording or searching for content or any of those listed above or others that would be apparent to a skilled person.

In the embodiment of FIG. 1 it can be understood that a large part of the user data comprises user history or user action data that represent user actions over a significant period of time. In various embodiments, there is a limit to how long user data is kept or used. For example in the embodiment of FIG. 1 after a threshold period, for example six months after being collected, items of user data are deleted. Thus, in some embodiments the user data for a particular user may include only relatively recent user action data, although the amounts of data may still be substantial.

In the embodiment of a FIG. 1, a distinction is made between different types of user and different sets of the tables are stored for the different types of users.

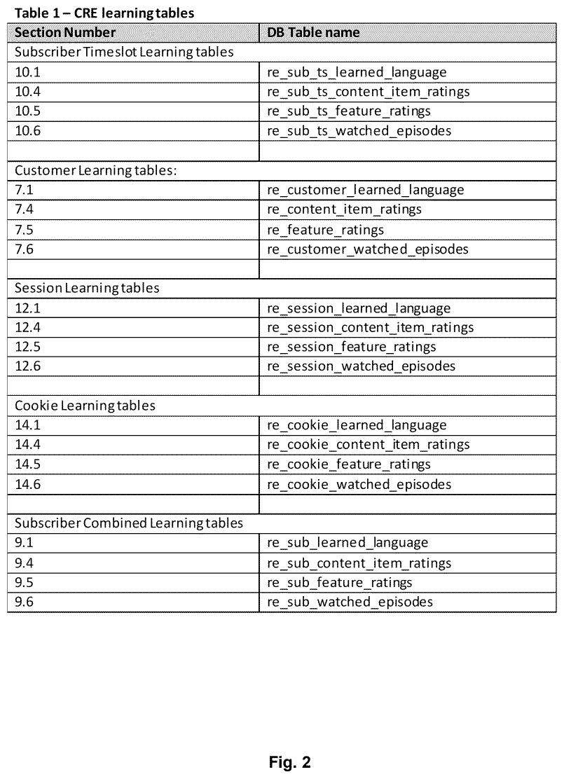

FIG. 2 is a representation of certain database learning tables stored on the hard disk storage resource 4 of the embodiment of FIG. 1. The system supports different categories of user. The tables of FIG. 2 correspond to different categories of user. The categories in this embodiment are: customer, subscriber and anonymous. Subscriber can, for example, refer to combined subscriber mode or time-slot subscriber mode. Anonymous can, for example, refer to cookie and/or session modes.

A customer may be a user who uses a service or content source. A customer profile may store one or more of the following attributes in some embodiments: preferred features; indication of preferred viewing times e.g. day, start and end times. The customer profile table also stores a list of the favorite content item group information: content source (e.g. EPG or VOD) and unique identifiers for content item groups.

A subscriber may be a person who has subscribed to a particular service rather than the individual who is using the service. For example, the subscriber can be an account holder or an entity that represents a household. Individual users may be associated with a subscriber. There are at least two modes of operation of subscriber profiles. The first is combined mode, where data for the subscriber (for example attributes and/or subscriber actions) are used to generate content recommendations. In that case, the content recommendations may be based on attributes and/or user actions for a plurality of individuals associated with the same subscription, for example different members of the same household. The second is time-slot mode where content recommendations are generated in dependence on the particular time slot in question. For example user data generated for a particular time slot may be used selectively in generating content recommendations for a particular time slot (potentially with user date generated for other times slots being ignored or weighted to be of less significance) and/or with different rules and/or attributes being used for different time slots. For instance, there may be a rule that no adult content be recommended for morning or afternoon time slots, only for late evening or night-time time slots. Similarly, greater weighting may be given to children's programs for certain time slots, for instance late afternoon time slots, making recommendations of children's programs more likely during those time slots.

Anonymous profiles are used to recommend content when neither the individual customer nor subscriber to a service is known. For example, for a web user who has not logged in is an anonymous user. There are two modes of operation of anonymous profiles. These are session mode (either single-session or multi-session mode) and cookie mode.

In single-session mode preferences of the anonymous consumer are stored in memory for the duration of a single session and then removed from memory at the end. In multi-session mode preferences of the anonymous consumer are kept in memory over more than one session. The anonymous profile is identified over more than one session using a unique session id stored in the anonymous profile.

In cookie mode, the recommendations engine 22 can perform anonymous session tracking using cookies, wherein on a first request a cookie containing the unique identification is added and in later sessions used to identify the anonymous user. This works in a web environment. A cookie session profile holds a list of cookies that are known to the system together with data referring to when the cookie was created or last accessed.

For each user of all categories, there may be separate groups of learning tables. In FIG. 2, the learning tables shown are “learned language”, “exclude content group”, “content item ratings”, “feature ratings” and “watched episodes”. These tables are shown by way of example. Other tables may also be stored in the embodiment of FIG. 1. Each user may have explicit preferences and implicit preferences. Explicit preferences are information the consumer tells the system by, for example, by entering a questionnaire. Implicit preferences are information learned by the system through user actions. Data corresponding to user actions for the purpose of learning are stored in the learning tables.

The learned language table 32 stores data relating to audio languages of content items that have been user actioned by the user. For example, the feedback table can store learned language information, the date at which the language was learned and an indication of whether or not the entry has been aged out.

The exclude content group table stores data corresponding to content explicitly excluded by the user. For example, the feedback tables also contain information on content items and content item groups that have been manually excluded by the customer. For example, for individual content items that have been excluded this information includes: identifier of the content item; content source; data and time of exclusion; series title of content item; client type ID (e.g. web, call center, set-top box). For content item groups, this information includes: customer identifier, time and date content item group excluded; content source; client type ID. In both case, a flag is included that indicated whether or not the exclusion has been aged out.

The content item ratings table stores data representing features of content such as the features, actors, channels. Feature ratings allows learn actions to specify features of content information instead of the content item. A customer is capable of applying ratings to a content item. Rating information is stored in the customer feedback table and includes: time and date rating given; customer identifier; activity identifier; name and identifier of content item rated; content item group identifier if content item associated with a content item group; rating value; a scaled rating value; feature ratings; content source ID; client type ID; series title of content item and content item instance identifier. A flag is also stored to indicate if a recommendation has aged out or not. A feature rating made by a customer can also be stored on a specific list of features and/or sub-genres.

The watched episodes table stores data corresponding to last actioned episode of a series actioned by a user. For example, for each customer the episode history for customers is stored. This includes a series identifier; a series title; a season and episode number, and the date and time the user action occurred.

In alternative embodiments, different data tables or combinations of data tables may be stored.

It can be understood from the description above concerning user learn actions that in a system with a large number of users, user data may be generated almost continuously as users watch programs and perform other actions. Such user data is stored in the hard disk storage 4.

It can be understood from the description of the nature of the user data, that for a particular user there may be large numbers of individual data items for each user, for example there may be individual data items for each individual relevant user action over the preceding 6 months or other predetermined or selected time period. For example each learn action (e.g. each time a user has watched or recorded a program at any time during the previous six months or other relevant time period) will have its own data item (e.g. table entry) in the user data. Thus there may be several hundreds or even thousands of data items (e.g. table entries) that need to be read from the hard disk storage 4 for a particular user.

It is a feature of the embodiment of FIG. 1 and at least some other embodiments that during a session for a particular user, the user data for that user may change or be added to. For example, a user may carry out a number of user actions. These may include, for example, switching channel or selecting new content items, watching a content item, pausing a content item, logging in and out of the service, recording of a content item on a PVR or other recording device, or even selecting a piece of content based on a content recommendation provided earlier in the content recommendation session. User actions are logged by the recommendation system 2 during the session. Some of these user actions are recorded as learn actions during the session. As discussed, the user learning module 24 has a set of rules for determining which user actions are learn actions.

A learn action may be based on an indication that a user has watched a content item for a specified period of time. The information may be used as an indication of user preferences. As discussed, a minimum event time filter may be implemented to ensure that short period events are not recorded and/or used. In this case, a learn action is only generated if an event exceeds the minimum event time filter. In addition, there may be a rule that only one learn action for each content item should be generated. For example, a viewer may watch a program and switch channels during an advert break and then return to the original program. In such an event, only one learn action may be generated according to some embodiments.

New user data, for example new table entries, corresponding to the learn actions for the user ultimately are stored in the hard disk storage 4. However, it is a feature of the embodiment of FIG. 1 and of at least some other embodiments that user data for the user stored in RAM 7 during a session for that user is updated, based on the learn actions for the user occurring during the session, on an ongoing basis. Thus, the user data for a user stored in RAM 7 may change during a session for the user, such that processes are performed based on the most up-to-date user data.

In the embodiment of FIG. 1, the user data for a user is overwritten by the user data stored in RAM 7 (which may be more up-to-date) in response to the end of a session for the user. For example, the updated user data can be provided to the hard disk resource 4 in response to an expiry event. An expiry event may be a user action corresponding to a user terminating a session, terminating watching a content item (e.g. the end of a program playback) or terminating recording of a content item. Alternatively an expiry event may occur a pre-determined period of time after a user action. For example, an expiry event may be a pre-determined period of time elapsing after a user action corresponding to a user commencing a viewing session.

In some embodiments, all of the user data for the user stored in the hard disk storage 4 may be overwritten by the user data stored in RAM 7. Alternatively, only changes to the user data may be written from RAM 7 to the hard disk storage 4. In some embodiments user data is written to the hard disk storage 4 periodically or in response to at least one of processing capacity or communication capacity being available. Higher priority may be given to updating the user data in RAM 7 than to updating the user data in the hard disk storage 4.

In some embodiments, the user data for a user may be maintained in RAM 7 after the end of a content recommendation session for the user and only deleted from RAM 7 in response to the user data from RAM 7 having been written to the hard disk storage 4.

In at least some other embodiments, each time new user data is generated (for example, when a learn action is generated during a session for a user) it is written both to RAM and to the hard disk storage 4. Thus, an attempt may be made to maintain up-to-date user records for the user in parallel in both RAM and the hard disk storage 4. For example, one option is to provide the updated user data to the hard disk storage 4 at substantially the same time as updating the user data in the user cache 6. Alternatively, priority may be given to maintaining up-to-date user data in RAM 7, with the user data in the hard disk storage 4 only being updated on an as-and-when basis.

Information relating to content available on a real-time linear television broadcast may also be received by the user device and is typically presented to a viewer via an electronic program guide. The electronic program guide is interactive. The information relating to the real-time linear television broadcast may be provided by either the service provider or by a third-party content information provider. The information may be delivered to the user device as part of the broadcast or may be provided through alternative means. For example, an internet enabled set-top box may receive a satellite broadcast carrying the content but receive information relating to the broadcast via an internet connection.

The user devices of the system of FIG. 1 comprise or have associated with them local storage devices in the form of PVRs, and each PVR may be considered to represent a content source. Each user may have a PVR for recording broadcasted content and/or for downloading and storing previously broadcast content. The PVR may be part of a user's set-top box or it may be a separate device. The recorded content is stored on a memory of the PVR to be viewed at a later time. FIG. 1 shows a set of n personal video recorders: PV1, PV2, . . . , PVn. Each PVR corresponds to a different user. Each PVR has a collection of content recordings stored on their respective memories. Typically each PVR will have a different selection of stored programs from the other PVRs. However, more than one PVR may have one or more common programs stored on their memories at a given time. For example, user of PVR1 and user of PVR2 may have recorded or downloaded the same content item or series of content items. Each PVR may have content items that are not available from other content sources, for example because they are not made available on VoD or have not been re-broadcast. This may also be a result of the age of the content item. For example, the content item may have been available for a certain amount of time from another content source but is no longer available.

In alternative embodiments, the PVRs or other data stores for storing content for users may be implemented in forms other than local storage devices. For example, the data stores may be implemented as storage areas in a cloud storage system or other networked, remote, and/or virtual storage system.

The PVR communication module 12 of FIG. 1 is an interface between the PVRs 20a, 20b, . . . 20z and the recommendation system 2. The recommendation system 2 collects identifying information relating to the content items stored on the PVRs 20a, 20b, . . . 20z. Content items from the PVR of the user can then be taken into consideration in generating content recommendations.

In alternative embodiments, any other data stores, for instance local storage devices, for example any storage devices included in or associated with user devices, may be used as well as or instead of PVRs. In some embodiments, the data stores may comprise data stores forming part of a cloud storage system or other remote and/or networked and/or virtual storage system. Furthermore, the items of content in question are not limited to comprising video content and may comprise any suitable type of content, for example audio content, image content, virtual reality content or augmented reality content.

There is description above concerning metadata or other content information that may be used by the system. Content information may, for example, include contain scheduling information (e.g. start and end times for programs, series information) together with content information regarding the program itself (e.g. program description, age rating information).

Content items, for example programs, that are scheduled in an electronic program guide have associated content information (metadata). Information about content available from this source is stored in the EPG content source table. In a similar fashion to EPG content items, information for video on demand (VOD) content items are stored on the VOD module 10. EPG content items and VOD content items sharing certain characteristics can be arranged into groups. In addition to above, content items are stored on PVRs and have associated information. A group of EPG content items may be considered as equivalent to a broadcast television channel. VOD content items can be grouped into logical groups, for example, movie categories. VOD content item groups can be used to enable or restrict access to content items on a per customer basis. PVR content information is collected and stored in the PVR table 32.

For each content item group, either EPG or VOD, the information that is stored may include: an identifier for the group; a name for the group; a flag indicating if the group is free to view and therefore available to all customers; an indicator of video format of the group e.g. unknown, standard definition, high definition and 3D; one or more language labels; primary and secondary geographic area information. Concerning VOD content item groups, the primary and secondary geographic information can be used to allow customers from different countries access to different content. If the group is associated with a channel then an identifier and mapping to the channel may also be stored. One or more content item groups can be associated with a channel number.

Single content items (e.g. programs) also have associated information and characteristics. Stored content item information can be constant or variable. Constant content item information has values that are the same for all instances of the content item. Variable content item information has values that vary between different instances of the content item. For example, the same episode may be shown at two different times. The two instances of the same episode share constant characteristics, such as duration and rating but different schedule times, for example.

Constant content item information includes: a unique identifier; duration of the content item; the certificate of the content item e.g. the age rating; the year the content item was released; the critic rating for the content item; the original audio language for the content item; the season and episode numbers; series title information and/or identifier; content item description, and a primary language. The primary language may or may not be the same as the original audio language. For multi-language content items, translations of the title and description can be stored. Furthermore, available broadcast language information can be stored and an indicator to indicate the type of language available. For example, the language may be primary audio language, dubbed audio, subtitled and/or signed.

Further information stored for content items includes: genre and sub-genre information and names associated with the content item. A given name can be associated with, for example, an actor or director involved with or appearing in the content item. For a given name associated with the content item, an identifier for the role in the content item is also stored. In addition, an indicator of the rank of importance of the name and/or the role in the content item may be stored. The rank may be high for a more important role in the content item. For example, a given actor playing a leading part would be assigned the highest rank available.

Although the system of the embodiment of FIG. 1 includes hard disk storage 4 and RAM 7, any suitable other memory devices or types of storage may be used as well as or instead of the hard disk storage 4 and/or RAM 7 in alternative embodiments.

As part of a session, the content recommendation engine is configured to offer a number of operations to be called using an API. As an example, the content recommendation engine is configured to offer to content recommendation request.

A user 205 watching a television program that they have selected on user device 40. Data representing the user's activity is sent to the recommendation system 2 and a learn action, as mentioned above, is performed that results in at least one user data item for that user being added to at least one of the tables. The user data item may comprise data concerning the item of content and data concerning the viewing, for example start and stop times for the viewing.

The collection of data items stored in the tables concerning the user, for instance, viewing of content by the user may be referred to as a user record for the user. The user record may also be referred to as a user profile.

As a non-limiting example, a user record or user profile may include information that a user has played an episode of Game of Thrones on 14 Jul. 2022, has downloaded an episode of The Simpsons on 15 Jul. 2022, and has just watched an episode of Top Gear on 15 Jul. 2022. The user record will also include metadata associated with each item of content in the record. For example, the meta data items cars, supercars and engineering are associated with the Top Gear episode. In practice there will be many more items of meta data associated with each item of content. In general, a user record will include records of far larger numbers of items of content. However, such a small number of items content might be found for a new user or for a temporary user of a system. For example in some embodiments, the system may be used for a user who is a guest in a hotel or traveler in a vehicle or transport system.

The user data in respect of the user is sent to the content recommendation engine 22 (of the content recommendation system 2) in order to generate or update a user profile for the user 50.

The content recommendation module 22 in this embodiment then performs a search of various data sources, for example in the cloud, to determine any other information concerning the item of content. The data sources can include EPG module, VOD module and other data sources. For example, various databases can be consulted that include additional information concerning television programs or other items of content.

In the present embodiment, the record for the item of content and any other information found from the search of data sources is subject to processing to match the meta data and other information for the item of content to an ontology of meta data terms that are maintained by the system. Thus, the meta data for the item of content can be enriched, corrected or supplemented.

In the present embodiment the ontology consists of around 38,000 features that can be used as meta data to represent items of content. The ontology defines features in the format <context>:<keyword>. Features describe the content and include subjects, settings, themes and characters (for example, Wimbledon may contain the terms-subject: tennis, sports competition: Wimbledon, theme: sports). Any other suitable ontology can be used in other embodiments. In some embodiments, no ontology is used and the raw metadata associated with the item of content (for example, provided by the content maker, distributor or broadcaster) is used without amendment or enrichment.

The metadata for the item of content is then stored in the user record or user profile in the user profile table 30 in the hard disk storage 4.

As described above, each user has a stored user record or user profile. The system is configured to provide a plurality of content recommendation candidates to a user based on the similarity between the user record and the content metadata.

Operation of the system of FIG. 1 is described in the following. As a first stage, the user 205 initializes a viewing session through a first initiation event. An initiation event can, for example, be a user logging on to a service provider or turning on the user device 40. The initiation event is communicated to the content recommendation module 2 via a communication channel between the user device 40, for example a set top box or other device, for example at the user's home or other remote location, and the content recommendation module 2. In the embodiment of FIG. 1 there is direct communication between the user device 40 and the content recommendation module 2. In alternative embodiments, communication between the user device 40 and the content recommendation module 2 is mediated or passes through, for example a content provider, for instance a TV system operator to which the user subscribes. The initiation event may be treated automatically by the content recommendations module as being a request for recommendations for the user.

In response to the initiation event, the user is then presented, via a display of the user device 40, with a content selection screen displayed on a display screen and/or user interface, which presents the user with a choice of viewing different content items from the content source. For an EPG content source, the content selection screen may form part of the EPG itself. For a VoD content source, a dedicated user interface may be presented. It is a feature of the embodiment of FIG. 1 that the choice of content items includes content recommendations generated by the content recommendation system of FIG. 1 and communicated to the user device. In one mode of operation it is a requirement that the content recommendations should be provided almost instantaneously, for example within a few hundred milliseconds, so that they can be included on the user interface together with other available items of content, for example live TV schedules, as soon as the user interface is displayed to the user.

In response to the initiation event a start time to the viewing session is logged by the CRE 22, for example, to coincide with the initiation event, a content recommendation session is opened and user data, associated with the user, are retrieved from storage on tables in the hard disk storage resource 4 and loaded to the user cache 6 in RAM 7. The user data are maintained in RAM 7 throughout the content recommendation session.

The CRE 22 also maintains content data in the RAM 7, for example any suitable data relating to properties of the content, such as metadata obtained from the EPG module 8 and the VoD module 10. The content data stored in RAM 7 may be updated periodically or in response to changes in the data stored, for example, at the EPG module 8 and VoD module 10. By caching the content data in RAM processing and data access speed may be increased.

Following retrieval of user data and obtaining content source information, the CRE 22 is configured to use the user data located in the user cache 6 together with the available content information as part of a content recommendation process.

Once the CRE 22 has performed the content recommendation process, the content recommendation(s) generated by the CRE 22 are then transmitted to the user device 40 either directly or indirectly. In some embodiments the content recommendation(s) are transmitted to a database, server or other device, for example a third party device. The content recommendation(s) may be further processed and/or may be transmitted onward to then user device either immediately, at a later time or upon request. The content recommendation(s) may be transmitted in any suitable fashion either to the user device, or to the database, server or other device. In the present embodiment, software installed at the user device 40 determines whether or how the content item recommendation are displayed on the user interface.

It can be understood that the time constraints on providing content recommendations can be significant, given that personalised content recommendations may need to be generated on the fly, particularly as it may be necessary to provide personalised content recommendations for tens of thousands, hundreds of thousands, or even millions of users substantially simultaneously in the case of systems with large numbers of users and during busy periods such as peak viewing periods.

It will be understood that the CRE 22 may maintain content recommendation sessions for a plurality of the users and may maintain in the RAM user data for said plurality of the users substantially simultaneously. For example, user data may be maintained in the RAM 7 for thousands, hundreds of thousands or even millions of users substantially simultaneously, depending on the RAM storage capacity available and the number of subscribers or other users associated with the system.

At the start of a content recommendation session for a user the user data, including all of the various table entries, for the user, are read from the hard disk storage 4 and stored in the user cache 6 in RAM 7, or any other suitable local or rapidly readable storage resource in alternative embodiments. Throughout the content recommendation session the user data stored in the user cache 6 in RAM 7 is used by the CRE 22 to generate content recommendations for the user. This can provide a significant time saving compared to having to read the user data from the hard disk storage 4 each time a content recommendation is needed during the session. At the expiry of a session, the user data for the user is deleted from the cache. The expiry of the session may occur for example in response to no user actions have been received for a pre-determined time period, in response to a user logging off a session or switching off a user device, or in response to loss of communication with the user device. If a new content recommendation session for the user subsequently begins, the user data is read again from the hard disk storage 4 and stored in the user cache 6 in RAM 7.

There is description above concerning metadata or other content information that may be used by the CRE 22 in providing content recommendation. The content information can contain scheduling information (e.g. start and end times for programs, series information) together with content information regarding the program itself (e.g. program description, age rating information). In some embodiments, metadata items may be mapped from an ontology (e.g. the ontology of 38,000 items) to other metadata items in the ontology. Weightings or confidence scores are associated with the mappings in some embodiments. The ontology represents a pre-determined set of properties and/or parameters. The content metadata for content items (or as collected in user data) corresponds to properties and/or parameters selected or assigned weights and/or values from this pre-determined set. The at least one property of the piece of content may comprise a set of tags or other metadata representing properties of an item of content. In the system, the metadata may be stored on hard disk storage in metadata table 33.

As part of a content recommendation session, a number of different types of recommendation procedures may be available to be requested. These include procedures, for example based on a weighting, scoring and/or matching process based on previous user actions, and matching to available content. In a simple example, if it is determined from the user data that a user has previously watched movies starring a particular actor, or watched football matches featuring a particular team, then the CRE 22 may produce a recommendation for the user to watch a movie or other content featuring that actor, or a program concerning that football team, if such movie, program or other content is currently available or will soon be available via the available content sources. It will be understood that the content recommendation procedures may be more sophisticated and, may be for example based on similarities or cross-correlations between different content parameters and user actions and properties based on large amounts of historical data. At least one of the recommendation procedures may use a machine learning derived model to determine recommendation candidates. As a non-limiting example, machine learning techniques such as clustering algorithms for clustering objects that share similarities, such as K-means clustering or neural network based techniques and/or Kohonen based techniques may be suitable.

The content information, specifically, the content metadata may correspond to values for one or more properties or parameters or characteristics, such as program title, time, duration, content type, program categorisation, actor names, genre, release data, episode number, series number, style, mood, language and theme. The properties or parameters or characteristic may include one or more of the following: Audience; Award; Category; Character; Character Type; Concept Source; Director; Format; Franchise; Host; Milieu; Mood; Producer; Person; Subcategory; Scenario; Setting; Sports Competition; Studio; Style; Subject; Team; Theme; Time Period; Writer. These properties or parameters will be understood as a non-exhaustive and non-limiting list. The metadata is represented by metadata items having a value for such properties or parameters. The collected metadata can be considered as representative of user interests and/or preferences based on previous interactions with the content. The metadata items may be provided together with a score so that the metadata represents a degree of the preference or interest for that content property or parameter. The content metadata of the user data may be referred to as user profile features. Content metadata attributes may also be referred to as facets. The following, non-limiting and non-exhaustive list of facets is provided: Actor; Audience; Award; Category; Character; Character Type; Concept Source; Director; Format; Franchise; Host; Mileu; Mood; Producer; Person; Subcategory; Scenario; Setting; Sports Competition; Studio; Style; Subject; Team; Theme; Time Period; Writer. It will be understood that in addition to facets, a number of other categories of content attributes may be used. For example, the desired context may be defined, at least in part, by descriptive content metadata or alternative content characteristics, such as, running time, language, format, age rating. In general, any property or parameter or characteristic capable of distinguishing a sub group of available content from other available content can be used as a content attribute or content metadata. For example, metadata categories as described above or other content information may be suitable. It will be understood that a context can correspond or represented by combination of context attributes. In some embodiments, the context may be associated with at least some of the content that is currently being displayed to a user via the user device.

It will be understood that content metadata described may also be assigned to one or more visual indications. In some embodiments, the visual indication metadata is selected from the same set of metadata categories listed above. In some embodiments, metadata items selected from the set describe above is assigned to the visual indications, for example, via a metadata enriching or expansion process.

In some embodiments, the metadata of the visual indications is selected form the same set as the content metadata. In some embodiments, the metadata stored in the user profile and the visual indication metadata includes a score associated with metadata categories selected from the same set.

In addition to user data, the visual indications, in the present embodiments, images, also have associated visual indication metadata. In some embodiments, the visual indication metadata corresponds to the metadata of the content items. For example, the visual indication metadata represents scores for the same metadata categories as the content metadata and/or user data.

As described above user data may be provided as a user profile. A user profile includes metadata items corresponding to metadata categories collected based on the user history. Each metadata item may have an associated weight that represents the users preference for content associated with that metadata item.

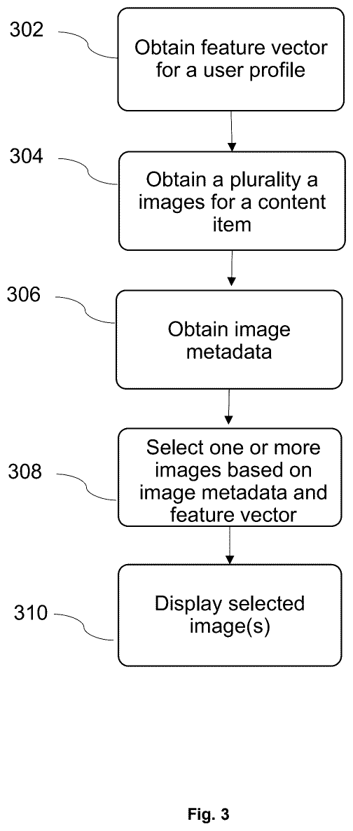

FIG. 3 depicts a method for selecting one or more visual indications or representations for a content item for display on a content selection interface, in accordance with an embodiment. In the following embodiments, the visual indications are images and the method correspond to a method for selecting one or more customized images. It will be understood that other visual indications or visual representations of the content items can be selected. For example, these may comprise digital image or other visual data. These may include, for example, videos or sequences of images, for example, in a Graphical Interface Format (GIF). In some embodiment, the visual indications may be or may be presented as thumbnails. It will be understood that the visual indication may be any media capable of being tagged with associative metadata.

The method can be incorporated into a workflow, for example into a content recommendation workflow or other content selection interface workflow. Alternatively, the method may be performed independently of a content recommendation workflow. In the method of FIG. 3, the selection of the image is based on a user profile, for example, a user profile stored on hard disk storage. The user profile is obtained based on user actions as described above and with reference to FIG. 1.

At step 302, user data in the form of a feature vector is obtained, for example, generated by the user profile module 26 or from the user profile table 30. The feature vector represents user data for a user. In particular, the feature vector is based on or forms part of a user profile that is determined using historical content engagement data. The feature vector may be obtained or generated by user profile module 26 or may have been previously generated and stored on hard disk storage 4, for example, in user profile table 30.

Step 302 may optionally include performing one or more filtering steps for the feature vector. For example, the one or more filtering steps may include selecting the features of the feature with the highest weight and therefore the most important features. Other filtering steps may be performed, for example, features may be selected based on category and/or other criteria. In some embodiments, the feature vector is truncated or constrained to be a pre-determined. In some embodiments, the truncation is performed at a later stage of the method, for example, after obtaining the image metadata.

At step 304, a plurality of images are obtained for a selected content item. The images may be referred to as image candidates. In the present embodiment, image files are stored on visual indication store 53 and retrieved by visual indication module 51. In other embodiments, the images are stored and retrieved from EPG module 8, VOD module 10 or other data sources 14. Without limitation, the selected content item may be a content item that is recommended as part of content recommendation process performed by content recommendation engine.

At step 306, image metadata for the plurality of images are obtained. In some embodiments the image metadata has been previously pre-determined and is stored, for example, on image store 53, and obtained together with the images at step 404. In other embodiments, image selection module 51 analyses the images retrieved at step 404 to obtain the image metadata. In some embodiment, the image metadata may be represented as a feature vector in which the features are represented as entries in the feature vector. In some embodiments the obtained image metadata are image metadata obtained by previously processing the image.

In some embodiments, an image processing procedure is performed on the plurality of images either as part of the method or before the start of the method. The image processing procedures may be an object recognition procedure or a facial recognition procedure configured to identify objects or particular actors in the image. The image processing procedure may be a semantic image processing procedure. The image processing procedure may comprise mood and/or theme detection procedures that are configured to determine one or more moods or themes in a picture. In some embodiments, both image and image metadata is obtained from a content provider and the method includes a step of enriching the obtained image metadata. In the above-described embodiments, image processing procedures are described for obtaining properties of one or more images. In embodiments with alternative visual indications, alternative visual indication processing procedures may be used, for example, video processing procedures.

In some embodiments, obtaining the image metadata includes the steps of mapping third party metadata (i.e. metadata provided from an external data source or a data source outside the content recommendation system) to a pre-determined set of first party metadata categories. Such a mapping step may be referred to an enriching process the metadata. The mapping may be performed by a machine learning or other language model. The enriched metadata associated with the metadata can then be used for the selection of the image. Enriching of the metadata to align metadata categories between user data and the image data may improve the comparison between image metadata and the user data. In some embodiments, enriched metadata is provided by the third party.

In the present embodiment, the image metadata for each image represents one or more visual aspects or visual features of the image. For example, the image metadata may represent a mood or a theme. As described above, the user profile includes metadata items selected from an ontology. In some embodiments, the visual aspects and/or visual features obtained by analyzing the image correspond directly to metadata categories of the ontology. For example, an image may have a particular actor, setting, scene or object or an event that directly corresponds to a metadata category. In some embodiments, the visual aspect or feature found in the image is mapped onto the ontology.

The image metadata, either obtained via processing of the image or from a third party, may include metadata relating to the appearance and/or content of the image. For example, the metadata may include one or more items representing the identity or describing a visual event or a subject or an object in the image. In some embodiments, a setting, for example, a location, or a scene may be represented by the metadata. In some embodiments, a mood, theme or sentiment of the image may be represented by the metadata. In some embodiments, the metadata include an identifier or descriptor for a visual event and/or one or more people, objects or scenes of the visual indication.

As a non-limiting example, an image may be of a particular actor or city, and the metadata associated with the image may be the name of the actor. As a further example, the image may convey a certain mood or sentiment, which corresponds to or may be mapped onto a content metadata category. As a further example, the image may include a specific event, for example, an event indicative of a content genre, for example, an action scene indicative of an action movie or sports scene indicative of sport content.

In some embodiments, the image metadata is delivered via a third party, for example, from a further data source. The image metadata may be stored remotely with the image. In some embodiments, initial third party metadata is further enriched, for example, by mapping initial third party metadata onto the ontology described above. In some embodiments, the enriched metadata for each image is verified.

An image enriching process may ensure that the image metadata correctly reflects the image. The image metadata may include features such as character types, setting, moods and themes.

In some embodiments, following the image processing step, the image metadata is stored for later use, to avoid performing the image processing step in a subsequent image selection process.

At step 308, the visual indication selection module, also referred to as the image selector 52 processes the image metadata and the user profile data, in particular the feature vector to determine an image of the plurality of images that is best suited or best matched to the user profile. This process include performing a comparison of the obtained image metadata for the plurality of images and the feature vector.

In embodiments, the comparison comprises a mathematical operation to determine a level of match or similarity between the image metadata and the user data. The comparison may comprise a matching process to match the best suited image to the user to provide a customized image.

In some embodiments, the matching process may comprise identifying matches between metadata of the user and metadata of the image. In some embodiment, the matching process comprises finding common metadata between the user data and the metadata of the image. Common metadata includes metadata items and categories which are shared by the user profile and the visual indication.

In embodiments, the user data is represented as a feature vector in a multi-dimensional vector space, referred to in the following as a user vector. The vector space has a dimensional size that correspond to the plurality of metadata categories. In embodiments, each component of the vector corresponds to the metadata score. In such embodiments, each of the images is represented as a corresponding vector in the same vector space, referred to as image vectors. A measure of overlap or distance between the user vector and the image vectors is performed. In one embodiment, a dot product is performed between each user vector and the corresponding image vector to determine a score for each image vector and the selection of the image is based on the highest score. In such a way, the image vector that has the highest degree of overlap or projection onto the user vector in the vector space is found. In other embodiments, a measure of distance between the vectors may be used. The method may comprise selecting the visual indication based on the closest visual indication vector to the user vector. While a dot product is described other mathematical operations specific to the vector space may be used to perform a comparison and to select the image.

In other embodiments, a level of match between the user data and each image is found by counting common metadata items between the user data and the image metadata. The image that has the largest number of common metadata items based on the count may be selected for display.

The output of the dot product, for example, or the count of common metadata, may represent the degree of relevance or match of the image to the user and may be referred to as a relevance score. As such, in embodiment, the selection of the image may be based on the highest relevance score corresponding to the most relevant image.

It will be understood that a typical user profile may have a large number of features, for example, tens of thousands of features and a particular image will have a much smaller number of features, for example, up to tens of features. The matching process may take into account this difference in vector size.

In some embodiments, more than one image may be determined to be a close match to the user profile and the selection process includes a random selection between the closely matching images. In some embodiments, more than one image may be determined to be the closest or most similar to the user data, in which case a random selection may be performed or other metric may be used, such as the success of one image over another in the general population (or within a group of users). In some embodiments, the visual indication may have a property including a score representing a conversion rate, for example, the rate at which display of the visual indication for the content item results in selection of the content item and the selection of the visual indication may be based, at least in part, on this property. The conversion rate may be specific to a type of user or a group of users.

At step 310, the selected image is displayed on user device 40, for example, via a content selection interface governed by UX engine 12.

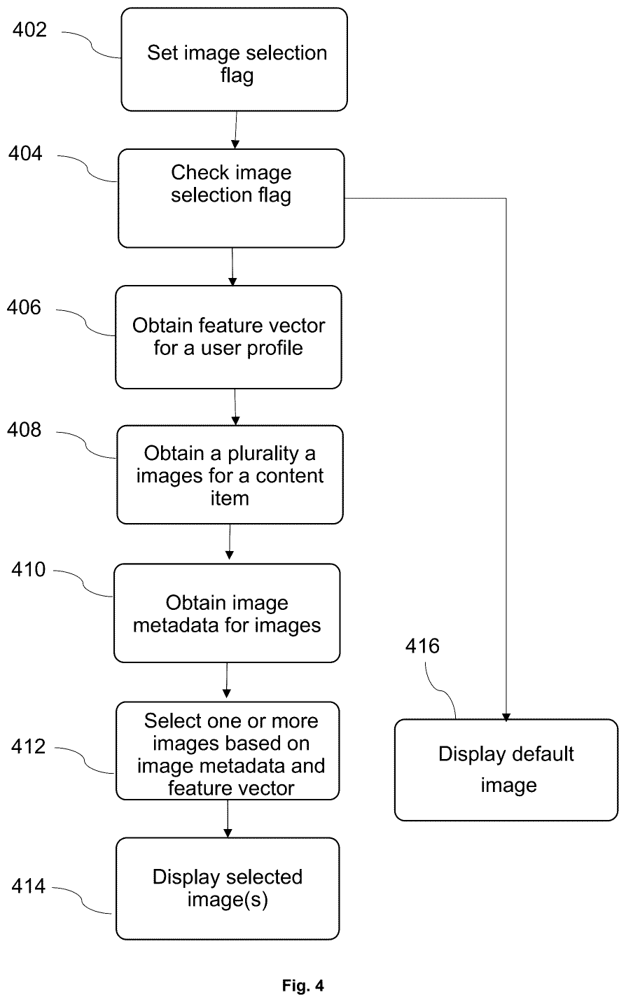

The method of FIG. 3 relates to a method of selecting one of a plurality of image candidates based on user data. It will be understood that selection of images during user of the content recommendation system by a large number of users may pose technical challenges. In some embodiments, one or more steps of the method are performed in dependence on a priority score assigned to the content item and/or on current or predicted system performance. FIG. 4 provides an example embodiment, in which the image selection is performed in dependence on other properties, such as an image selection flag.

As an example, at a given time, the image selection interface may display images for 10s or 100s of content items. It will be understood that performance may be affected if an image selection process is performed for each content item simultaneously for multiple users. In some embodiments, such performance issues may be addressed to a certain degree by relying on previously determined image metadata rather than performing the image analysis step. In some embodiments, the image selection process may be performed only for a subset of the content items of the content selection interface, for example, the content items that are assigned a higher priority score.

At step 402, an image selection flag is set. The image selection flag may be set based on an assigned priority score for a content item and/or based on a current or predicted system performance and/or an engagement metric.

In some embodiments, the image selection flag is set based on one or more of a system performance metric, a prediction of system performance or system load and performance metric of a content selection interface. The method therefore may further include a system performance analysis. In some embodiments, the image selection flag is set based on predicted performance of the system, for example, based on the number of requests at that time. In some embodiments, the image selection flag is based on an engagement metric. Such a metric may include a measure of user engagement with the content

In some embodiments, the image selection flag is set based on a priority score of a content item. The priority score may be assigned based on a determined value or other pre-determined criteria.

As a first example, the image selection flag can be set based on current system performance or a prediction of system performance. As a non-limiting example, under a heavy or a predicted heavy load a content item may be assigned a lower priority score to reduce additional processing in the selection of images. The system performance may relate to performance of the recommendation system and may represent or be dependent on the number of recommendation requests currently being processed. The priority score may relate to performance of the UX engine. In some embodiments, the flag may be set based on an analysis of network performance, for example, based on a network performance parameter such as, latency, lag, speed.

In some embodiments, the image selection flag is set based on a priority score assigned to a content item based on current or predicted performance of the content selection interface. For example, the content selection interface may be requesting images for a large number of content items, such that analyzing or otherwise selecting an image for each content item is not possible without an undesired delay.

In some embodiments, the priority score for a content item is determined based on a content recommendation process. For example, a content recommendation process may return an ordered list of content items for a user where the ordering is based on, for example, similarity of content metadata to user data such that better matches are higher in the list. A priority score may be assigned based on the content item recommendation ordering. For example, a higher priority score may be assigned to content items that offer a better match to a user data. In other embodiments, a higher priority score may be assigned to content items that offer a lower match to user data, in order to drive user engagement with the lower match items.

The metadata for a visual indication may include content metadata. For example, the metadata for the visual indication may be mapped on to a set of metadata items or categories that are stored for the content item.

In some embodiments, a content recommendation process may include amongst the content item candidates one or more content items that are subject to a commercial or other business rule. Such items may be assigned a higher priority score. By assigning a priority score, system resources may be optimized.

Step 402 may include evaluating a priority score for a content, for example, by comparing the priority score to a threshold value and setting the flag based on the comparison. Step 402 may alternatively or additionally include comparing one or more system performance parameters to threshold values and setting the flag accordingly.

At step 404, a determination of the flag is performed. If the flag is set to true the method continues to step 406. If the flag is set to false, the method continues to step 416.

Step 416 corresponds to a default image being selected in place of performing an image selection process. In some embodiments, in place of a default image being selected, a random image from a plurality of images is selected.

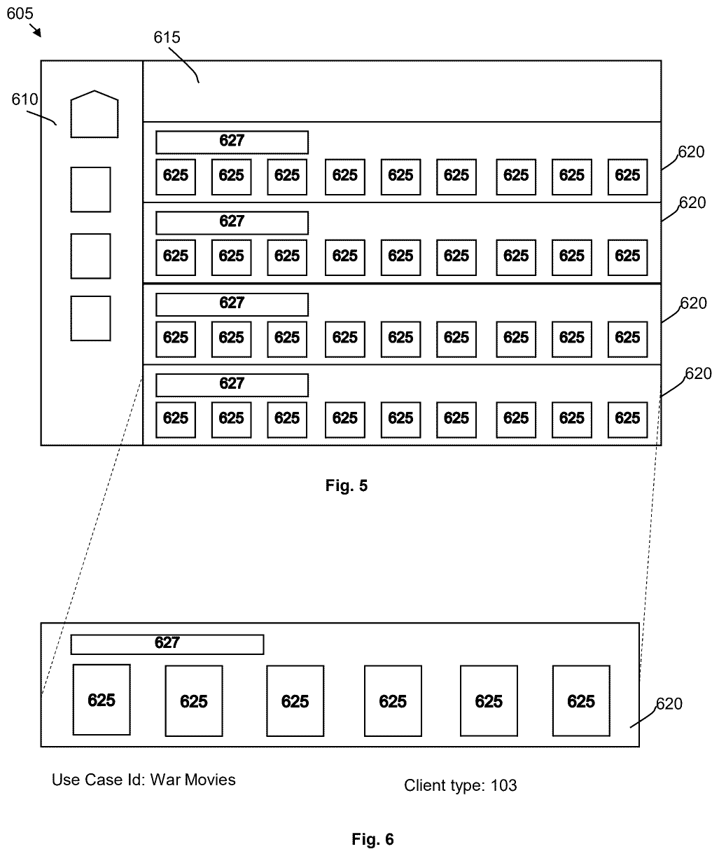

Steps 406, 408, 410, 412 and 414 of FIG. 5 correspond to the steps 302, 304, 306, 308 and 310 respectively, of the method of FIG. 4.

FIG. 4 depicts a method in which an image selection flag is set dependent on a priority score or system performance metric. In some embodiments, the image selection flag may be based on a property of the content item itself, for example, the priority score. In further embodiments, the image selection flag or the image selection process itself may be based on a property associated with the visual indication itself.

In an example embodiment, each visual indication for a content item may have an associated score that represents user engagement, for example, popularity, of the content item based on the visual indication. For example, a content item may be more popular when a particular visual indication is displayed. As such, the selection process may be based on the user engagement score of the visual indications themselves.

In some embodiments, content items having low user engagement may be given priority for visual indication selection to drive further engagement. In some embodiments, content items having high user engagement or predicted high user engagement may be displayed via a default image.

User engagement metrics can include popularity or recency. These may be determined at a global level or may be specific to user segments. In some embodiments, user engagement scores for content items amongst a segment of users to which the user belongs may be used in the image selection process.

In further embodiments, a step of tracking visual indication specific metrics may be performed. The visual indication specific metrics may include user engagement metrics, such as popularity, based on the visual indication. In some embodiments, one or more factors contributing to a popularity of a content item may be determined, in particular, the effect of presenting a visual indication to a user having certain preferences may be tracked. In some embodiments, it is tracked if a content item is popular due to the customized visual indication, for example, by comparing the popularity of different visual indications for the content item on similar users and measuring user engagement.

FIG. 5 shows an example of a content selection interface 605 for display of one or more selected visual indications, as selected via the methods described above. In this example, the content selection interface 605 optionally comprises a high level menu bar 610 down one side that can contain functions such as “home page”, “search”. The depicted content selection interface is configured to display visual indications in the form of images, however, other visual indications may be displayed in other embodiments.

The content selection interface 605 further comprises a headline banner 615 that is optionally always fixed at the top of the content selection interface 605 or at least is provided as the first selectable item in the content selection interface 605 at least until such time as an operative may change the headline banner 615.

Beneath the headline banner 615 is a plurality of carousels 620, each carousel 620 containing a respective group of content. In this example, each carousel 620 comprises a plurality of selectable content indications 625, each content indication representing a different content item in a group of content represented by that carousel 620. In the present embodiment, content indications are visual indications, in particular images. Thus, in the content selection user interface, each carousel 620 corresponds to and shows a corresponding different group of content, and each content indication 625 represents and indicates a different item of content from the group of content that can be selected by the user 205 by selecting the corresponding content indication 625.

In use, a user 205 can scroll up and down through the carousels 620, with new carousels 620 representing different groups of content appearing at the bottom and the top carousel 620 disappearing at the top as the user scrolls down through the carousels 620 and vice versa as the user 205 scrolls up through the carousels 620. When the user 205 identifies a carousel 620 corresponding to a group of content of interest, the user 205 can scroll from side to side along the carousel 620 to scroll through the selectable content indications 615 representing the items of content 515 in the group of content associated with that carousel 620.

A detail view of a carousel 620 representing a group of content from the content selection interface 605 is shown in FIG. 6, which shows a plurality of selectable content indications 625, each representing a different user selectable content item. The content indications 625 may comprise a visual indication, for example, a thumbnail showing an image associated with the item of content and/or text indicating the name of the content 515 or the like. In particular, in the present embodiments, the visual indications or content indications include an image, either provided as a thumbnail or as other size for the content.

In use, the groups of content represented by each carousel may be generated by a content recommendation process or procedure, for example, based on user data. While a user scrolls and interacts with the content selection interface, the images presented to the user, in this embodiment via the carousel, are selected based on user data, as described with reference to FIGS. 3 and 4 above. As such, a user is presented with customized images on the content selection interface.

When a user identifies the content represented by the content indication 625 that they want to consume, then the user 205 selects the desired content indication 625 from that carousel 620 to request provision (e.g. download, streaming or viewing) of the item of content 515 represented by that content indication 625. It will be understood, that there are many arrangements of content selection interfaces and the present disclosure is not limited to the particular arrangement of content selection interface 605 shown in FIGS. 5 and 6. For example, in alternative content selection interfaces, the user 205 can scroll through groups of content/carousels 620 horizontally (or in any other direction) and scroll through the content indications 625 representing content items vertically (or in another direction that is different from the direction through which the groups of content are scrolled through). Some content selection interfaces may be arranged in a hierarchical structure, with the user able to drill down through groups of groups of content, into groups of content and finally down into content items. However, various other arrangements would be apparent to a person skilled in the art and to which the concepts of the present disclosure could be applied and the present disclosure is not limited to the content selection interface 605 shown in FIGS. 5 and 6.

The content items in the groups or the groups themselves can optionally be picked by an operative or selected by the content recommendation engine (CRE) 22 for that user. The ordering of at least some of the groups of content in the content selection interface 605 is customized/specifically determined for that user 205 based at least in part on previous user actions relating to, e.g. during use of, the content selection interface 605 (or other content selection interfaces 605).

Although a particular system arrangement is shown in FIG. 1, there are various system arrangements that could be used.

FIG. 7 shows a “middleware” arrangement in which the recommendation system 2 sits as “middleware” between the users 205 and systems of a content provider 210. The recommendation system 2 is implemented by processing resource 220 (which may comprise one or more processors) with the storage device 4 and user cache 6. In some examples, the recommendation system 2 can be implemented by a cloud computing system, by one or more servers or other suitable enterprise level computing system. In this arrangement, systems that implement the recommendation system 2 receive data sent from the user devices 40 of the users 205 that represents the user actions/user activity taken by the user 205 that are relevant to the content selection interface, such as but not limited to actions taken by the user 205 during operation of the content selection interface, including one or more of the user actions listed above. The user devices 40 also provide a user ID that can be used to identify the user 205 to allow the provision of a content selection interface that is customized for that user 205. The user devices 40 communicate the data over a network, such as the cloud 215, to the recommendation system 2. The recommendation system 2 records the user actions in order to generate learn actions and build and update a user profile that can be used to configure and customize a content selection interface for the user 205. The recommendation system 2 can communicate the requests and other data from the user devices 40 to the content providers systems 210 in order to provide the content to the user devices 40. Access between recommendation system 2 and the visual indication store 53 may be provided via a network such as the cloud 215.

FIG. 8 shows an alternative system configuration in a “backend” processing arrangement. In this arrangement, the user devices 40 interface directly with the systems of a content provider 210, which implements the content selection interface and handles the requests from the user devices 40. User interaction data from the user devices 40 is provided by the systems of a content provider 210 to the recommendation system 2 in order for the recommendation system 2 to identify learn actions and build user profiles for at least partly customizing the content selection interface for that user. The recommendation system 2 provides the data for customizing the content selection interface for that user, including an ordering with which to present at least some of the groups of content in the user selection interface, to the systems of a content provider 210 for providing in the content selection interface for that user 205. Access between recommendation system 2 and visual indication store 53 may be provided via a network such as the cloud 215.

The processing resource can optionally comprise one or more processors, FPGAs, ASICS or the like, which may be provided in a single machine or distributed over a plurality of machines, and may be locally arranged or remote from each other and connected over a network. The processing resource 220 is configured to communicate with content databases, such as the EPG module 8, to retrieve content available from the content provider. The processing resource 220 comprises rapid access storage, such as user cache 6, which may be implemented in RAM or SSD storage to provide fast access to user profiles and actions that the processing resource is currently, and will next be, performing operations on. The processing resource is also configured to communicate with external storage such as storage device 4 on which user actions and profiles are stored and can be retrieved into the use cache 6 when needed by the processing resource 220.

The system described herein can be used to provide a content selection method and system that may in some examples allow a user to more quickly identify content of interest and to better navigate content available from a content provider system.

Although various specific examples have been described above, these are provided to help understanding of the present disclosure and other possible implementations can be used. For example, although specific arrangements of systems and networks that could be used to implement the concepts disclosed herein are shown in FIG. 1, FIG. 7 and FIG. 8, other systems architectures could be used. For example, the UX engine 12 could be provided as a stand-alone system rather than being integrated with the content recommendation engine 22 or integrated into a content provider system rather than being provided as a separate intermediate or backend system.

Method steps described herein can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customized circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented with a user device 40 having a screen, e.g., a CRT (cathode ray tube), plasma, LED (light emitting diode) or LCD (liquid crystal display) monitor, for displaying information (e.g. the content selection interface 605) to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

The above embodiments describes collection of user data. It will be understood that in some embodiments, the system may be configured such to restrict or not allow access to personal information, or data that could be used to determine the name of a user, or demographic information concerning the user.

The above description of specific embodiments is made by way of example only. A skilled person will appreciate that variations of the described embodiments may be made without departing from the scope of the invention.

What is claimed is:

1. A computer-implemented method comprising:
obtaining user data for a user, wherein the user data comprises or represents user activity and/or content metadata associated with user activity;
obtaining metadata and/or one or more other properties associated with a plurality of visual indications associated with a content item;
selecting one or more of the plurality of visual indications based on at least the user data and the visual indication metadata and/or the one or more other properties of the visual indication; and
displaying the selected one or more visual indications, for example, as part of a content selection interface.

2. The method of claim 1, wherein the metadata and/or the one or more properties associated with the plurality of visual indications represent or are indicative of at least one of: an identity of a visual event, subject or object in and/or a setting or scene of the visual indication; a mood, theme or sentiment of the visual indication.

3. The method of claim 1, wherein the visual indications comprise at least one of an image, sequence of images, video or other visual format.

4. The method of claim 1, wherein the method further comprises performing one or more visual indication processing procedures, for example, image processing procedures, to obtain the metadata and/or one or more other properties for the plurality of visual indications.

5. The method of claim 4, wherein the visual indication processing procedures comprise at least one: an object and/or facial recognition procedure and/or a mood and/or theme and/or sentiment detection procedure.

6. The method of claim 4, wherein the visual indication processing procedure comprises processing said plurality of visual indications to identify one or more metadata properties from a pre-determined set of properties and, optionally, storing said one or more identified properties as metadata for the visual indication.

7. The method of claim 1, wherein the plurality of visual indications are obtained from a third party, for example, a content provider or other data provider and processed to assign first party metadata, for example, metadata from a content distribution system and/or middleware operator.

8. The method of claim 1 wherein the plurality of visual indications are obtained together with metadata from a third party and wherein the method comprises processing the set of visual indications to enrich and/or expand third party metadata and wherein the selection of the visual indication is based on the enriched and/or expanded metadata.

9. The method of claim 1, wherein the method comprises performing a matching process between the user data and the visual indication metadata to identify matched or common metadata and selecting the visual indication based on said matched or common metadata.

10. The method of claim 1, wherein the user data is represented as a feature vector in a vector space and the method comprises representing the one or more visual indications as vectors in the same vector space, wherein the selection process is based on determining a distance between or a measure of overlap or projection between the user vector and the vectors representing the one or more visual indications.

11. The method of claim 10, wherein the method comprise determining a measure of overlap and/or projection between the feature vector for the user and the visual indication vectors and wherein the selection is based on the measure of distance and/or overlap and/or projection.

12. The method of claim 1, wherein the selection of the visual indication is dependent on a priority score for a content item or the visual indication and/or on current or predicted system performance and/or on a user engagement score for the content item and/or for the visual indication.

13. The method of claim 1, wherein the selection of the visual indication is performed in dependence on one or more of:
d) a system performance metric
e) a prediction of system performance or system load
f) a performance metric of a content selection interface.

14. The method of claim 1, wherein the metadata and/or other property of the visual indication comprises a user engagement score representing previous user engagement with the content item for the visual indication and wherein the selection of the user engagement is based on said user engagement score.

15. The method of claim 1 wherein the method comprises tracking user engagement for a content item dependent on the visual indication presented to the user and storing a score for each visual indication representing said user engagement, wherein the selection of the image is based on said user engagement score.

16. The method of claim 1, wherein the method comprises determining whether to display a default image or to select one or more visual indication based on at least one of: a user engagement metric, a priority score and/or system performance metric.

17. The method of claim 1, wherein the metadata comprises or represents one or more content parameters, properties and/or characteristics, for example, at least one of: program title, time, duration, content type, program categorisation, actor names, genre, release data, episode number, series number, style, mood, language and theme.

18. The method of claim 1 wherein the user data may be representative of one or more preferences of the user and selecting the visual indication is based on said one or more preferences, optionally, wherein the one or more preferences are determined based on historical content engagement data collected for the user.

19. The method of claim 1, wherein the method comprises obtaining a group of content item recommendation candidates and wherein the method further comprises selecting a visual indication for one or more of the content item recommendation candidates based on metadata and/or one or more properties of the visual indication.

20. The method of claim 19, wherein the visual indication selection is performed for a subset of content item recommendation candidates based on a priority score and/or current or predicted system performance and/or an engagement metric.

21. A system comprising processing circuitry configured to:
obtain user data for a user, wherein the user data comprises or represents user activity and/or content metadata associated with user activity;
obtain metadata and/or one or more other properties associated with a plurality of visual indications associated with a content item;
select one or more of the plurality of visual indications based on at least the user data and the visual indication metadata and/or the one or more other properties of the visual indication; and
display the selected one or more visual indications, for example, as part of a content selection interface.

22. A non-transitory computer-readable medium that comprises computer-readable instructions that are executable to:
obtain user data for a user, wherein the user data comprises or represents user activity and/or content metadata associated with user activity;
obtain metadata and/or one or more other properties associated with a plurality of visual indications associated with a content item;
select one or more of the plurality of visual indications based on at least the user data and the visual indication metadata and/or the one or more other properties of the visual indication; and
display the selected one or more visual indications, for example, as part of a content selection interface.
